(19) United States
(12) Patent Application Publication
(10) Pub. No.: US 2008/0160990 A1
(43) Pub. Date: Jul. 3, 2008

(54) System, method and apparatus for identification of power control using reverse rate indication

(76) Inventor: Yair Karmi, Bridgewater, NJ (US)

Correspondence Address: Pearl Cohen Zedek Latzer, LLP, 1500 Broadway, 12th Floor, New York, NY, 10036, US

(21) Appl. No.: 12/003,781

(22) Filed: Dec. 31, 2007

Related U.S. Application Data
(60) Provisional application No. 60/877,664, filed on Dec. 29, 2006.

(51) Int. Cl. H04Q 7/20

(52) U.S. Cl. 455/424

(57) ABSTRACT

A method, system and apparatus for determining power control signals, for example, power control bits received by a mobile station. Some applications requiring power control information may not have access to the baseband processor, which may decode the relevant information sent by the base station. According to embodiments of the invention, power control information may be determined or at least estimated with a degree of reliability by reading the total power transmitted by the mobile station and the data rate of the transmission.

### CROSS-REFERENCE TO RELATED APPLICATIONS

This application claims the benefit of U.S. Provisional Patent Application No. 60/877,664, filed on Dec. 29, 2006, which is incorporated in its entirety herein by reference.

### FIELD OF THE INVENTION

The present invention relates to mobile communication systems using reverse power control, and in particular, mobile wireless systems using reverse power control that may have variable transmission rates.

### BACKGROUND OF THE INVENTION

In many wireless systems such as CDMA (cdma200, EvDO), W-CDMA (UMTS, HSDPA, HSUPA, HSPA), GSM, or TDMA, a base station may control power on a reverse link, e.g., from a mobile station to a fixed base station by transmitting to a mobile station a reverse power control signal indicating to the mobile station a desired change in reverse link transmission power. This control may be designated reverse power control, (RPC), reverse power control bit (PCB), transmitter power control (TPC), etc.

A reverse power control may typically be decoded by a wireless station baseband decoder, for example, among or as part of additional control information the mobile station may receive from the base station. Control circuitry in the mobile station may then apply this decoded reverse power control signal to determine a desired change in transmitted power, and perform the required change.

However, such applications may not necessarily have access to the baseband processor of the mobile station, which may decode the received signal to obtain the reverse power control signal.

Merely recording total power transmitted may also not be sufficient, as parameters additional to the power control signal may also be used to determine the total power to be transmitted by a mobile station. Such parameters may include, among others, which channels are active at any time, a relative power of each channel as may be determined by a specific air interface standard, system parameters transmitted by a base station, and a data rate at which these channels may operate. Thus, in many cases, the reverse power control cannot simply be determined by measuring whether the total output power of the mobile station has increased or decreased.

### SUMMARY OF THE INVENTION

Applications operating on the mobile station may require knowledge of the reverse power control signal transmitted by the base station. An example of such an application may be an application controlling a transmission parameter in a transmit diversity device. For example, an application in a transmitting device having more than one transmitting antenna may use the power control bit, or PCB, sent by the base station in order to determine the diversity control parameter. The parameter may be any one or more of phase difference between the transmitted signals, or power ratio between the transmitted signals, e.g., relative allocation of total transmit power to the different transmit antennas.

The theory and benefits of mobile transmit diversity are described in other patent applications assigned to the assignee of the present invention, and need not be discussed herein. Reference is made, for example, to US Patent Publication No. 2003/0002594, the entire contents of which are incorporated herein by reference.

Embodiments of the invention relate to wireless systems that apply reverse, or uplink, power control to determine a power that may be transmitted from a mobile station to a fixed base station. A base station that may receive a wireless station transmission may determine a reverse power control based on the power level of the received transmission. The base station may send a reverse power control signal to the mobile station to modify the power of the signal transmitted by the mobile station.

In some embodiments of the invention, an application operating on the mobile station may process, manipulate, or otherwise require data pertaining to the reverse power control signal transmitted by the base station. However, in some systems, the application may not operate at the baseband or data frequency, but may be limited to operating and processing data in the radio frequency (RF) band. Therefore, the application on the mobile station may not have access to the reverse power control signal as decoded, for example, at the baseband frequency or at the data level.

According to embodiments of the invention, the PCB may be estimated by an application overlaid on the baseband processor and not having access to parameters manipulated by the baseband processor. In particular, some embodiments of the invention may addresses systems where the uplink data rate varies frequently, such as EvDO Rev A or WCDMA Rel 6 onwards.

The change in the reverse link or transmit power of the mobile station, e.g., the change in uplink transmit power, is mainly a function of the change in data rate, the PCB, and the rules of the air interface.

According to embodiments of the invention, the PCB or reverse power control signal received at the mobile wireless station may be determined based on one or a sequence of transmission parameters of the mobile station. For example, a sequence of transmission parameters may be analyzed to deduce, infer, estimate, or otherwise determine one or more reverse power control signals received by the mobile station. One transmission parameter that may be analyzed to deduce the reverse power control signal may be a reverse traffic data rate, or reverse rate indication (RRI) that may be transmitted by a mobile wireless station to a base station. The reverse rate indicator (RRI) indicates the data rate of the uplink transmission.

Some embodiments of the present invention may access a value related to the RRI, which when associated with the actual rate of reverse transmission of the mobile station may provide a limited reliability indication in terms of value and the transmission time this value refers to.

According to embodiments of the present invention, the reverse power control signal may be determined from other measurable or accessible parameters, for example, in the radio frequency (RF) signal.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic block diagram of some components of a mobile wireless station in accordance with an embodiment of the present invention;

FIG. 2 is an exemplary block diagram of a wireless system in accordance with an embodiment of the present invention; and

FIG. 3 is an exemplary flowchart illustrating a method in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to embodiments of the present invention, a reverse power control may be received by a mobile wireless station from a based station. A module in the mobile wireless station may determine a reverse power control using analysis of power and/or RF parameters, which may include any one or a plurality of total power transmitted by the mobile station, channel activity of wireless channel that may be detectable from fluctuations in a transmission power and/or an indication of a reverse link traffic data rate.

Embodiments of the present invention may use a statistical relationship between parameters that may be received by an RF receiver of the mobile station, which may characterize: signals transmitted by the mobile station, and a power control used by, control circuitry of the mobile station to determine a transmit power level. This statistical relationship may be computed by a processor connected to the receiver in such a way as to measure or monitor relevant parameters, for example, transmit power level.

By way of background, the total power transmitted by a mobile wireless station may be expressed as:

Pₜ=k_{RPC}·Σ(Pᵢ·Aᵢ), (1)

where Pₜ may be a linear power (in units such as Watts) that the wireless station may transmit, Pᵢ may be a relative power that may be transmitted by each channel, where a reference may be 1, for example a pilot channel power, Aᵢ may be the activity of a channel at a time of measurement, e.g. Aᵢ=1 when a channel may be active and 0 when it may be inactive; and k_{RPC} may be an overall multiplication factor that may be determined by a reverse power control.

According to a first embodiment of the invention, depicted in FIG. 1, a mobile wireless station 110 in wireless system 100 may be constructed and operate according to embodiments of the present invention. Base station 120 may transmit a reverse power control to mobile station 110, and mobile station 110 may transmit on antenna 111 using a power level based at least in part on the reverse power control. The total transmitted power may be determined by monitoring or measuring the power (or a portion thereof) provided by the mobile station 110 to at least one transmit antenna 111 of the mobile station. For example, as depicted in FIG. 1, a transmit power may be measured by a coupler 112 in the RF transmit path, for example, between a power amplifier (not shown) and the antenna 111. The coupler may tap the power output of the transmit path and provide the sample data to a power detector 113, which may measure the power output of the transmit path and provide an output representing the power level to a processor 114.

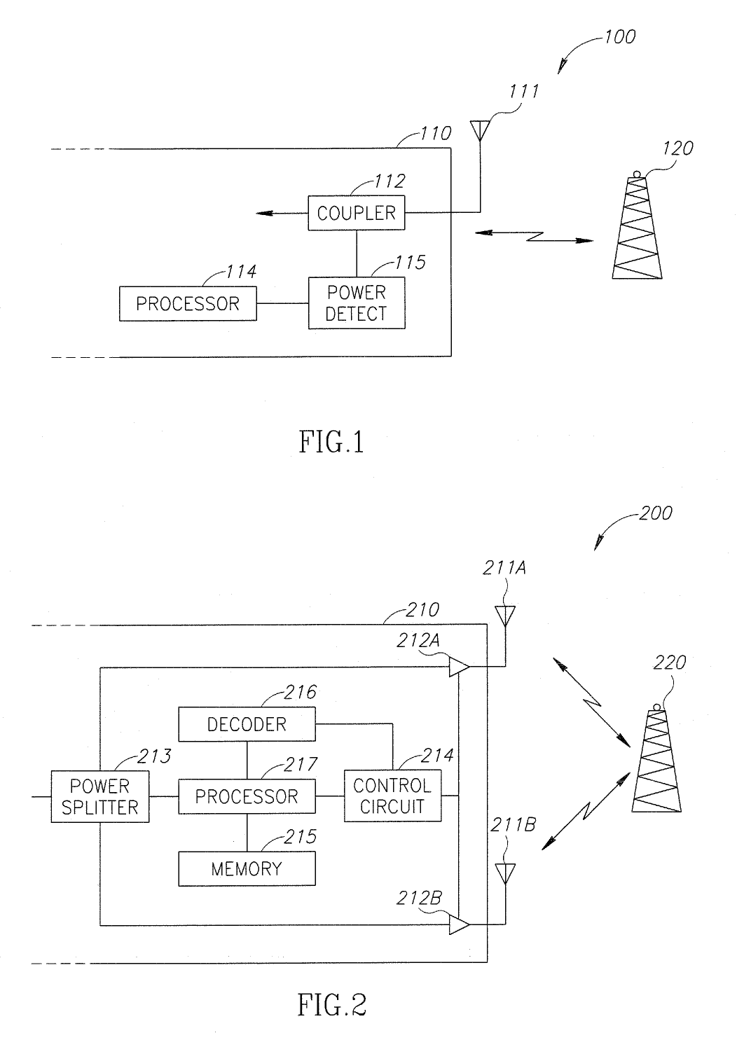

According to an embodiment of the invention depicted in FIG. 2, in wireless system 200, a total power transmitted by mobile station 210 to base station 220 may be determined by measuring a control signal that may control a transmit power. Such control signal may include digital and/or analog controls to an upconverter (not shown) that may feed a power splitter 213 and/or controls of one or more power amplifiers 212A and 212B, for example, no amplification, low amplification, medium amplification, high amplification, etc., feeding transmit antennas 211A and 211B. These controls may be specific to an architecture or a specific implementation of a wireless station 210, and may be implemented by a control circuit 214. Using a wireless station power calibration table, for example, which may be stored in memory 215, controls may be translated by decoder 216 and a processor 217 into a total transmitted power. A power calibration table may provide a transmitted power for one or more values of parameters. For example, controls may be compared with linear interpolation of values in a calibration table to find a transmit power value that may correspond to transmit controls.

In another embodiment of the invention, a variation in an activity of one or more channels, or a variation in accessible controlling signals of one or more channels may support synchronization of a power control determination logic. A similar concept may be described, for example, in U.S. patent application Ser. Nos. 11/265,334, 11/258,937, and 11/259,433, the entire contents of which are incorporated by reference herein.

According to embodiments of the invention, channel activity may be determined from variations in transmit power within one time unit per an air interface, for example, in the time unit designated as a slot. Channels that may be active in a first half or a second half of a slot may cause a change in a power that may be characteristic of a corresponding relative power, and may therefore be determined to be, for example, active or inactive per a presence or an absence of such characteristic power changes.

According to embodiments of the invention, a wireless transmission, whose purpose may be, among other purposes, data transmission, may have a variation in a transmission data rate. Such variations in data rate may cause changes in a total power in the order of, for example, 10:1 or more.

According to embodiments of the invention, a relative power that may be associated with a traffic channel may be determined from a data rate of transmission, which may in turn be provided by a data rate indicator. The data rate indicator is also referred to herein as a reverse link rate indicator or a reverse rate indicator (RRI). The RRI may be associated with characteristic system parameters that may be determined by, for example, an air interface or network defaults. Accordingly, RRI may be used to determine a power associated with a data transmission. The determination may be implemented in various ways, for example, using a calculation process or a lookup table associating an RRI as an input with an associated transmission power level as an output

Therefore, using any of the embodiments discussed or other embodiments of the present invention, the transmission power level may be determined. Accordingly, all the parameters of Equation (1) may be determined, except k_{RPC}. For example, Pₜ, the linear transmission power transmitted by the mobile station may be determined; Pᵢ, the relative power transmitted by each channel may be determined; Aᵢ, the activity of any channel at the time of measurement may be determined. Accordingly, using Equation (1), k_{RPC}, the overall multiplication factor determined by the reverse power control may be determined.

In some wireless networks such as, for example, EvDO Rev A or HSUPA, a data rate may change frequently and a RRI may not be available with a time stamp or other time indicator associating one or more RRI with an exact time of a transmission. In such a configuration, for example, multiple reverse rate indicators may be available for any particular time, which do not necessarily have a direct indication as to which transmission time is associated with each RRI. Some embodiments of the invention may associate based on statistical or probabilistic analysis a power transmitted at any time with a most probable RRI. Based on the most probably RRI, a transmit power associated with the traffic data rate may be determined.

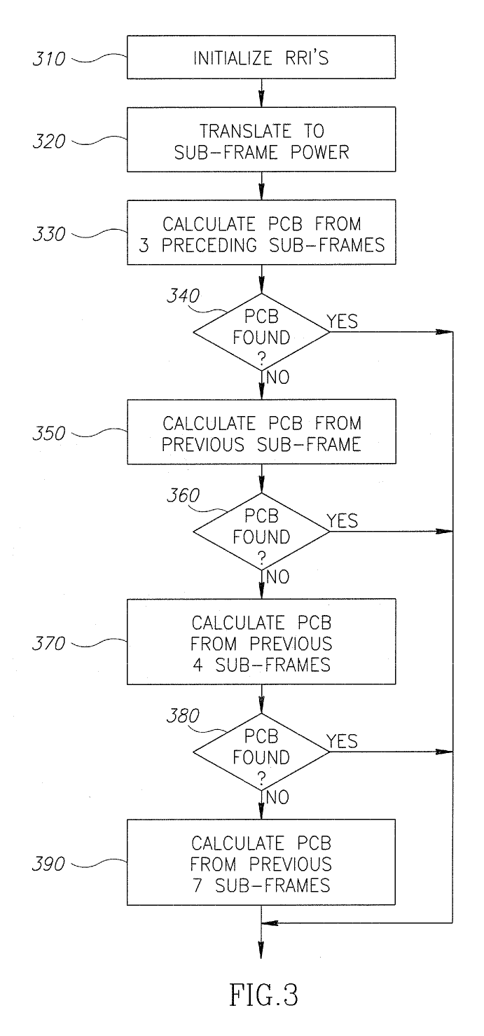

One embodiment of the invention may apply to a wireless system that may use a communication standard, such as EvDO Rev A, where a power control bit (PCB) decoding process may be as exemplified by a method depicted in FIG. 3. For example, in a CDMA 2000 EvDO Rev A standard, a total uplink transmit power may be a summation of a data channel and other channels. Each channel power may be determined by its channel gain that may be relative to a pilot channel, and may be according to a standard. Different RRI values may correspond to channels that may have different gains. A gain of another or a non-data channel may be constant.

A relationship between a data channel gain and a reverse channel data rate, that may be indicated by an RRI, may be given by a table as, for example:

| | | Data Chanel Gain | Data Chanel Gain |
|---|---|---|---|
| | | (dB) | (dB) |
| Payload Index | Payload (bits) | High Capacity | Low Latency |
| 0x0 | 0 | −∞ | −∞ |
| 0x1 | 128 | 0.75 | 6.75 |
| 0x2 | 256 | 3.75 | 10.00 |
| 0x3 | 512 | 7.00 | 13.25 |
| 0x4 | 768 | 8.75 | 15.00 |
| 0x5 | 1034 | 10.00 | 16.25 |
| 0x6 | 1536 | 11.50 | 18.00 |
| 0x7 | 2048 | 13.00 | 19.50 |
| 0x8 | 3072 | 14.25 | 19.25 |
| 0x9 | 4096 | 15.50 | 20.50 |
| 0xa | 6144 | 17.00 | 22.25 |
| 0xb | 8192 | 18.50 | 23.75 |
| 0xc | 12288 | 21.25 | 26.75 |
| 0xd | RESERVED | RESERVED | RESERVED |
| 0xe | RESERVED | RESERVED | RESERVED |
| 0xf | RESERVED | RESERVED | RESERVED |

Accordingly, when RRI information may be available, a data channel gain may be determined from the table, and applied to a reverse power control detection process, as detailed above. However, a measured signal change between different RRI values may not agree with theoretical values that may be listed in the table, and some values may require modification to be implemented. A new RRI table may be developed or updated based on real power measurements, and the updated values used.

Accordingly, when the exact data rate and mode of operation cannot be determined, e.g., “high capacity” or “low latency” in the example of EvDO Rev A, a procedure according to embodiments of the present invention may be optimized for the specific air interface that generates the most probable value of the PCB.

Reverse rate indicators that may be sent by mobile units may not be available with time indicators that may associate them with an exact time of a transmission. An embodiment of a reverse power control detection method for this situation may be shown by FIG. 3.

At block 310, reverse rate indicators (RRI) may be initialized, for example, where an initial value may be 0.

According to some embodiments of the invention, hypotheses of the data rate may be made. Since the data rate is determined by the RRI, the process according to embodiments of the invention may start with multiple RRI hypotheses based on the accessible indication and the prior history, and test them against the actual data. These “guesses” are referred to herein as RRI hypotheses.

As seen in the example embodiment of the present invention provided below, a first RRI hypothesis is provided. If the first RRI hypothesis does not provide a step of 1 dB that may be associated with a PCB, another RRI hypothesis is attempted, and so on. Any number of iterations is possible in accordance with embodiments of the invention. According to exemplary embodiments of the invention, the RRI hypotheses may be attempted in an order starting with the most probable events given history and indications and proceeding to least probable events. Values of transmit power may be compensated for data rates corresponding to these RRI hypotheses to determine the first one that provides “meaningful PCB” steps. In the general case, both past and future values may be used, since assumed history should be corrected to lead better future estimates.

At block 320, measured transmit power by means of RF, PDM and/or VMode may be translated and aligned with sub-frame boundary. Such translation may be performed by any suitable means, for example, by a calibration table that may be specific to a platform, or by a linear interpolation process, or by any other suitable method. A linear interpolation process may have an accuracy of, for example, 0.1 dB. The sub-frame power may be a PDM of a second half of a slot within a sub-frame, for example, slot 2 of slots 0 to 3. Logic may be used to determine a sub-frame RRI and a PCB, for example, by cycle through up to four sets of calculations, as shown in FIG. 3 blocks 330, 350, 370 and 390, as explained further below. Each set of calculations at blocks 330, 350, 370 and 390 may check for different possibilities of a RRI of sub-frame n (RRI(n)), the present sub-frame, and RRI of sub-frame n−1 (RRI(n−1)), the previous sub-frame. It will be recognized that this calculation method is one of a number of suitable possible methods in accordance with the present invention, and other methods of obtaining a reverse power control signal from one or more sub-frarne RRI's are possible.

A RRI hypothesis may be a RRI calibration table that may be derived from real power measurements. A net power of a sub-frame may be a total power subtracted by data channel gain, and may increase or decrease in accordance with a PCB. A PCB may be determined. A sub-frame power may be corrected in accordance with an RRI hypothesis, and may use an RRI calibration table, and may develop a net transmit power of a sub-frame that may be independent of a RRI. Accordingly, given a RRI hypothesis RRI(i), the power correction may be the difference between the power and the RRI power:

pwr_corr(i)=pwr(i)−pwrRRI(RRI(i)) (2)

A difference in total power between a present and a previous sub-frame may be:

dPwr(n)=pwr_corr(n)−pwr_corr(n−1) (3)

RRIs may be valid when dPwr(n) may be equal to a present system controlled power step, for example 1 dB, and may be up to an open loop correction limit.

At block 330, a first pass may be performed to calculate RRI(n) and a PCB. It may be assumed that RRI(n−1) may be correct, and possibilities for RRI(n) may be checked until dPwr(n) may approach a system controlled power control step, for example 1 dB based on:

dPwr(n)=pwr(n)−pwrRRI(RRI(n−3))−pwr(n−1)+pwrRRI(RRI(n−1)), (4)

where dPwr(n) may be a present sub-frame power, pwr(n), less a preceding sub-frame power, pwr(n−1), e.g. pwr(n)−pwr(n−1), and modified by a power correction for a sub-frame with an index of an RRI of a third previous sub-frame, RRI(n−3) and further modified by a power correction for a sub-frame with an index of an RRI of a previous sub-frame, RRI(n−1). If, for example, a present system controlled power control step may be 1 dB, then an acceptable first pass power difference for a 1 dB step, P1Thr, may have a nominal value of 0.41. If an absolute value of dPwr(n) falls between 1−P1Thr and 1+P1Thr, e.g., between 0.59 and 1.41, then RRI(n) may be set to RRI(n−3), and PCB(n) may be set to correspond to a positive or negative sign of dPwr(n), e.g.:

At block 340 a determination may be made as to whether a PCB has been found. If so, the PCB may be used for purposes of further calculation, for example, mobile transmit diversity control, for example, power ratio and/or phase difference between two or more transmitting antennas.

If no PCB has been found based on the calculation of block 330, then at block 350 a second pass may be performed to calculate RRI(n) and a PCB. In this pass, it may be assumed that RRI(n−1) may be correct, and possibilities for RRI(n) may be checked until dPwr(n) may approach a system controlled power control step, for example 1 dB, based on dPwr(n)=pwr(n)−pwr(n−1).

Thus, if, for example, a present system controlled power control step may be 1 dB, then an acceptable power difference for a 1 dB step, P1Thr, may have a nominal value of 0.41. If an absolute value of dPwr(n) may fall between 1−P1Thr and 1+P1Thr then RRI(n) may be set to RRI(n−1) and PCB(n) may be set to correspond to a sign of dPwr(n).

At block 360 a determination may be made as to whether a PCB has been found. If so, the PCB may be used for purposes of further calculation.

If no PCB has been found based on the calculation of block 350, then at block 370 a third pass may be performed to calculate RRI(n) and a PCB. It may be assumed that RRI(n−1) may be correct, and possibilities for RRI(n) may be checked until dPwr(n) may approach a system controlled power control step, for example 1 dB. A set, pRRI(n), may be defined using more than one recent RRI values, for example, four most recent different measured RRI values in sub-frame n, mRRI(n), that may have been input from among several previous sub-frames, for example the last 8 sub-frames, and a value of 0, for a total of 5 values in this set, e.g.,

{pRRI(i)}={4 latest different mRRI's among [mRRI(n) . . . mRRI(n−7)],0} (5)

and values of i may determine a finite set of possible values. Then dPwr(n) may be calculated as:

dPwr1(i)=pwr(n)−pwrRRI(pRRI(i))−pwr(n−1)+pwrRRI(RRI(n−1)), (6)

where d1(i) may be found from an absolute value of an absolute value of dPwr1(i)−1, e.g. d1(i)=abs(abs(dPwr1(i)−1)), and then a j may be found where d1(i) may be a minimum, e.g. d1(j)=min{d1(i)}. If d1(j) falls between 1−P1Thr and 1+P1Thr, then RRI(n) may be set to pRRI(j), and PCB(n) may be set to correspond to a sign of dPwr1(j).

At block 380 a determination may be made as to whether a PCB has been found. If so, the PCB may be used for purposes of further calculation.

If no PCB has been found based on the calculation of block 370, then at block 390, a fourth pass may be performed to calculate RRI(n) and a PCB. It may be assumed at this point, passes one to three, for example, blocks 330, 350 and 370, have not been able to calculate an RRI(n) and a PCB, and then all possible values of RRI(n−1) may be checked at block 390, until dPwr(n) may approach a system controlled power control step, for example 1 dB.

A set, pRRI(k), may be defined using more than one recent RRI values, for example, four most recent different measured RRI values in sub-frame n, mRRI(n), that may have been input from among several previous sub-frames, for example the last 8 sub-frames, and a value of 0. The set may include the latest 4 different mRRI values that may be input in a corresponding 7 sub-frames, as well as RRI(n−4), e.g. up to 5 values:

{pRRI(k)}={4 latest mRRI's among [mRRI(n−1) . . . mRRI(n−7)],RRI(n−4)} (7)

This result may be computed for all values of i and k, e.g.,

dPwr1(i,k)=pwr(n)−pwrRRI(pRRI(i))−pwr(n−1)+pwrRRI(pRRI1(k)) (8)

If, for example, a present system controlled power control step may be 1 dB, then an acceptable power difference for a 1 dB step, P2Thr, may have a nominal value of 0.61. Next, d1(i,k) may be found from an absolute value of an absolute value of dPwr1(i,k)−1, e.g., d1(i,k)=abs(abs(dPwr1(i,k)−1)), and then an may be found where d1(j1,j2) may be a minimum, e.g., d1(j1,j2)=min{d1(i,k)}. If d1 falls between 1−P2Thr and 1+P2Thr, then RRI(n) may be set to pRRI(j1) and PCB(n) may be set to correspond to a sign of dPwr1(j1,j2), otherwise, RRI(n) and PCB(n) may be set to 0.

It will be recognized that the method provided in the above process described in FIG. 3 is an example only. Different methods in accordance with embodiments of the invention, may go back any number of sub-frames, for example, up to 12 sub-frames back. The method implemented may depend on the air-interface standard and/or processing power of the processor; however, such methods are within the scope of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method of determining at least one power control signal received by a mobile communication device from a base station comprising:
measuring total power of an uplink transmission sent by said mobile communication device;
measuring a data rate of said uplink transmission; and
determining a power control signal based on said total power and said data rate.

2. The method of claim 1, wherein said mobile communication device sends said uplink transmission using a type of protocol selected from the group consisting of: Evolution-Data Optimized (EvDO) and Wideband Code Division Multiple Access (WCDMA).

3. The method of claim 1, further comprising determining a change between total power of said uplink transmission and total power of a previous uplink transmission, wherein determining said power control signal comprises determining said power control signal based on said change in total power and said data rate.

4. The method of claim 1, further comprising determining a change between data rate of said uplink transmission and data rate of a previous uplink transmission, wherein determining said power control signal comprises determining said power control signal based on said total power and said change in data rate.

5. The method of claim 1, wherein measuring a data rate of said uplink transmission comprises determining a reverse rate indicator (RRI) of said uplink transmission and wherein determining said power control signal comprises determining said power control signal based on said total power and said RRI.

6. The method of claim 1, wherein measuring a data rate of said uplink transmission comprises determining a plurality of reverse rate indicators (RRMs), and determining said data rate of said uplink transmission based on said plurality of RRIs.

7. The method of claim 6, wherein determining said data rate of said uplink transmission based on said plurality of RRIs comprises:
testing a first hypothesized data rate using said plurality of RRIs; and
if said first hypothesized data rate does not correspond to said plurality of RRIs, then testing a second hypothesized data rate using said plurality of RRIs.

8. The method of claim 7, wherein testing said first hypothesized data rate comprises determining whether said hypothesized data rate would produce a change in total power corresponding to said measured total power of said uplink transmission.

9. The method of claim 1, further comprising modifying a transmit diversity parameter based on said determined power control signal.

10. The method of claim 9, wherein said transmit diversity parameter is selected from the group consisting of phase difference and relative power of a plurality of transmit paths of said mobile communication device.
